(19) United States
(12) Patent Application Publication
(10) Pub. No.: US 2005/0078590 A1
(43) Pub. Date: Apr. 14, 2005

(54) Optical information recording method

(75) Inventors: Yasuo Sakane, Yokohama-shi (JP); Hideyoshi Horimai, Yokohama-shi (JP)

Correspondence Address: KODA & ANDROLIA, 2029 CENTURY PARK EAST, SUITE 1430, LOS ANGELES, CA, 90067-3024, US

(73) Assignee: Optware Corporation

(21) Appl. No.: 10/887,172

(22) Filed: Jul. 8, 2004

(30) Foreign Application Priority Data
Jul. 8, 2003 (JP) 2003-193966

(51) Int. Cl. G11B 7/24

(52) U.S. Cl. 369/59.25; 369/275.3

(57) ABSTRACT

It is an object of the invention to provide an optical information recording method which can store information with a simple control, with a high density, and accurately, and which can store information sequentially in holographic storage. A first information group is stored by illuminating a plurality of places of an optical storage medium under a first condition with information light and reference light for storage, and forming a plurality of first illumination regions a1 to a1+2 and c1 to c1+2. A second information group is stored by illuminating a plurality of places of the optical storage medium under a second condition with the information light and the reference light for storage so that second illumination regions overlap the first illumination regions at the same overlapping rate as each other, and forming a plurality of second illumination regions a2 to a2+2 and c2 to c2+2.

### BACKGROUND OF THE INVENTION

1. Field of the Invention

The present invention relates to an optical information recording method to store information by illuminating an optical storage medium with information light carrying the information by spatial modulation and reference light for storage, making the information light interfere the reference light for storage in an information storage layer of the optical storage medium, and using the resultant interference pattern.

2. Description of the Related Art

Holographic storage which stores information in a storage medium by utilizing holography has been generally performed by overlapping inside the storage medium information light carrying image information and reference light, and writing a resultant interference fringe pattern in the storage medium. When the stored information is reproduced, the storage medium is illuminated with reference light to cause diffraction attributable to the interference fringe pattern which reproduces the image information.

Recently, in order to obtain a super high data density in the holographic storage, volume holography, and more particularly, digital volume holography has been developed and is attracting attention in practical fields. The volume holography is a method of writing an interference fringe pattern on the three dimensional basis by actively utilizing a storage medium even in its thickness direction. The digital volume holography is a computer oriented holographic storage method, in which image information to be stored is limited to binary digital patterns while the storage medium and the storage method similar to of the volume holography are used. In this digital volume holography, for example, analog image information such as a picture is once digitized and developed into two dimensional digital pattern information, which is stored as image information. When the information is reproduced, this digital pattern information is read and decoded to return to the original image information, which is to be displayed. Therefore, even when an SN ratio (signal-to-noise ratio) is somewhat poor when reproducing information, it is possible to recreate the original information very truly by performing differential detection and error correction on encoded binary data.

In one example of storage in a hologram storage layer by the volume holography, the hologram storage layer is illuminated with information light carrying information to be stored and reference light for storage concurrently from a transparent substrate side for a given time so that an interference fringe in the thickness direction can be generated inside the hologram storage layer, an interference fringe pattern is fixed three dimensionally in the hologram storage layer. In result, the information is stored as a three dimensional hologram (refer to Patent document 1 and Patent document 2).

FIGS. 3(A) and 3(B) schematically show an example of an optical storage medium 1 in such a holographic storage. FIG. 3(A) is an outline cross sectional view of the optical storage medium 1 taken along a track 9. FIG. 3(B) is an outline plane view of the optical storage medium 1. The optical storage medium 1 is provided with a hologram storage layer 3 under a circular transparent substrate 2, and is fulrther provided with a reflection film 5 through a transparent intermediate layer 4. The optical storage medium 1 is constructed by bonding the foregoing components to a substrate 6. In the circular optical storage medium 1, the track 9 is provided concentrically or spirally (shown in dotted line in FIG. 3(B)). In the reflection film 5, a plurality of address servo regions 7 are arranged at a given angle interval in the radius direction. In a clearance between adjacent address servo regions 7 in the periphery direction, an information storage region 8 is provided. In the address servo region 7, information to perform focus servo control and tracking servo control, and address 5 information to the information storage region 8 are previously stored by embossed pit. As information to perform the tracking servo control, for example, warble pit can be used.

As a concrete construction of the optical storage medium 1, the transparent substrate 2 has, for example, a thickness of at most 0.6 mm as appropriate, and the hologram storage layer 3 has, for example, has a thickness of at least 10 μm as appropriate. The hologram storage layer 3 is made of a hologram storage material whose optical characteristics such as refraction factor, dielectric constant, and reflectance are changed correspondingly to intensity of laser beam when the hologram storage layer 3 is illuminated with the laser beam for a given time. As a hologram storage material, for example, Photopolymers HRF-600 (product name) of Dupont. make or the like is used.

A general storage apparatus which optically stores information in a plate-shaped optical storage medium comprises an optical head which illuminates the rotating optical storage medium with optical beam for information storage. In such a storage apparatus, information is stored in the optical storage medium by illuminating the optical storage medium with the optical beam for information storage by the optical head, while the optical storage medium is rotated. In such a storage apparatus, as a light source to generate the optical beam for information storage, a semiconductor laser is used in general.

As in the foregoing general optical storage apparatus, in the holographic storage, information is sequentially stored as hologram in given information storage positions of a plurality of information storage regions in the optical storage medium by illuminating the optical storage medium along the track 9 with the information light and the reference light for storage, while the optical storage medium is rotated. As in the general optical storage apparatus, in the case of storage utilizing the holography as above, it is desirable to use the practical semiconductor laser as a light source for the information light and the reference light for storage.

Such a volume holography has characteristics that diffraction efficiency can be improved by increasing a thickness of the hologram storage layer 3, and a storage capacity can be significantly increased by using multiple storage. The multiple storage is a method wherein illumination with the information light to store other information and the reference light for storage is performed to regions which overlap the regions wherein information is already stored by illumination with the information light and the reference light for storage. According to the multiple storage, a plurality of information can be stored in piles in the same illumination region, and a data density becomes significantly large.

Methods of the multiple storage include shift multiple storage method, in which illumination positions are shifted while part of the illumination positions are overlapped in the horizontal direction; and angle multiple storage method, in which an entrance angle of the information light or/and the reference light for storage in relation to the storage medium is changed.

FIGS. 4(A) through 4(C) explain the conventional shift multiple storage method. First, as shown in FIG. 4(A), an interference fringe pattern is stored by illuminating an illumination region al with information light to store first information and reference light for storage. In FIGS. 4(A) through 4(C), the track 9 is shown in dotted line. Next, as shown in FIG. 4(B), an interference fringe pattern is stored by illuminating an illumination region a2, wherein an illumination position is shifted in the horizontal direction so that part of the illumination region a2 overlaps the illumination region al with the information light to store the next information and the reference light for storage. After that, illuminating with the information light and the reference light for storage is performed by sequentially shifting illumination positions in the peripheral direction. When a row of al is fully illuminated, illumination position is shifted in the radius direction, and a row of b1, a row of c1, and a row of d1 are sequentially illuminated to store the information. In result, as shown in FIG. 4(C), information is stored in a whole area of the optical storage medium.

An Applicant of the invention has made an application of Japanese Patent Application No. 2001-376433 regarding the shift multiple storage method in the holography storage.

FIGS. 5(A) through 5(C) explain the conventional angle multiple storage method. In FIGS. 5(A) through 5(C), an entrance angle of reference light for storage is changed by operating a mirror and the like. First, as shown in FIG. 5(A), an optical storage medium is illuminated with information light 11 to store first information and reference light for storage 12. Then, the reference light for storage 12 enters the optical storage medium at a first entrance angle. Next, as shown in FIG. 5(B), an entrance angle of reference light for storage 14 is changed from the first entrance angle to a second entrance angle, and further, the reference light for storage 14 and information light 13 to store the next information enter the optical storage medium. Therefore, though a region where an interference fringe pattern is generated in FIG. 5(A) is the same region as a region where an interference fringe pattern is generated in FIG. 5(B), respective angles of the respective interference fringes are different. Therefore, information can be stored in piles in this same illumination region. Then, as shown in FIG. 6(C), an entrance angle of reference light for storage 16 is changed into a third entrance angle, and the reference light for storage 16 and information light 15 to store the information enter the optical storage medium.

Patent document 1:

Japanese Unexamined Patent Application Publication No. HI 1-311938

Patent document 2:

Japanese Unexamined Patent Application Publication No. 2003-99952

Nonpatent literature 1:

D. Pasaltis and other four joint authors, “Holographic storage using shift multiplexing,” Optics letters, USA, 1995, No. 20, p. 782

Nonpatent literature 2:

F. H. Mok, and other two joint authors, “Storage of 500 high-resolution holograms in a LiNbO₃ crystal,” Optics letters, USA, 1991, No. 16, p. 605 However, as mentioned above, in the holographic storage, the hologram storage layer 3 made of the hologram storage material whose optical characteristics such as refraction factor, dielectric constant, and reflectance and the like are changed correspondingly to intensity of laser beam is illuminated with the information light and the reference light for storage, and the resultant interference fringe pattern is thereby fixed. That is, in the hologram storage layer 3, photochemical reaction due to the information light and the reference light for storage is generated. Therefore, when the hologram storage layer 3 is illuminated with the information light and the reference light for storage and the information is stored in the hologram storage layer 3, reactant is consumed by the photochemical reaction, reaction product is produced, and a composition of the hologram storage layer 3 in the illumination region is changed from the composition before information storage. When the composition of the hologram storage layer 3 is changed, optimum intensity of laser beam is changed.

In the multiple storage, information is stored by performing illumination with the information light and the reference light for storage for the region which is already illuminated with the information light and the reference light for storage. Therefore, when laser beam having the same intensity is used, information storage state becomes uneven depending on multiplicity of the illumination region (number of times that information is written in piles in the illumination region). Therefore, in the multiple storage, it is preferable to change intensity of laser beam by adjusting illumination time and illumination energy correspondingly to compositions of the illumination region. A relation between change of composition due to illumination with laser beam and optimum intensity of laser beam in the composition can be obtained by experiments. However, in order to adjust intensity of laser beam, a complicated and tangled control has been required.

Further, in some materials for the hologram storage layer 3, a reaction rate of photochemical reaction is low. In this case, even when the hologram storage layer is illuminated with the information light and the reference light for storage, an interference fringe pattern is not fixed immediately, and time to fix the interference fringe pattern is required. In such a hologram storage layer 3 which requires time to fix the interference fringe pattern, when the hologram storage layer 3 is illuminated again with the information light and the reference light for storage before the interference fringe pattern is fixed, the ongoing fixation of the interference fringe pattern is influenced by the illumination. This has caused a trouble that hologram having sufficient intensity cannot be stored.

In the conventional angle multiple storage method, the same illumination region is illuminated with laser beam several times by changing entrance angles. Therefore, intensity of laser beam also has to be adjusted every time correspondingly to angles. For example, where multiplicity is m and number of illumination regions is n, adjustment of intensity and entrance angle of laser beam of m×n times has been required. Further, when time to fix the interference fringe pattern is necessary, sequential illumination is impossible and time for writing is long. Further, in the conventional angle multiple storage method, when the information is written, the optical storage medium is stopped and a plurality of information is written in one illumination region. After writing into the illumination region is finished, the optical storage medium is shifted or rotated. Therefore, time to shift the optical storage medium, or time to stop the rotation of the optical storage medium and time to start the rotation of the optical storage medium are required, leading to lowering of a transfer rate.

In the conventional shift multiple storage method, for example, when multiplicity in the periphery direction is m and number of rows in the radius direction (4 rows in FIGS. 4(A) through 4(C)) is n, regarding multiple storage in the periphery direction, though overlapping degrees of illumination regions are different for the first m times, overlapping degrees of the subsequent illumination regions are consistent. Therefore, it is enough to adjust intensity of laser beam for the first m times. However, when illumination places are shifted to the next row in the radius direction, intensity of laser beam has to again be adjusted for the first m times. In result, it is required to adjust intensity of laser beam m X n times. Further, in the conventional shift multiple storage method, information cannot be sequentially written in the hologram storage layer 3 which requires time to fix the interference fringe pattern, and writing time is long.

### SUMMARY OF THE INVENTION

It is an object of the invention to provide an optical information recording method which can store information with a simple control, with a high density, and accurately, and which can store information sequentially in holographic storage.

In order to attain the foregoing object, the optical information recording method of the invention is an optical information recording method, in which an optical storage medium is illuminated with information light carrying information by spatial modulation and reference light for storage, and an interference pattern between the information light and the reference light for storage in an illumination region is stored as the information, wherein a first information group is stored by illuminating a plurality of places of the optical storage medium with the information light and the reference light for storage under a first condition, and forming a plurality of first illumination regions, and wherein a second information group is stored by illuminating a plurality of places of the optical storage medium with the information light and the reference light for storage under a second condition so that illumination regions overlap the first illumination regions, and forming a plurality of second illumination regions.

The invention has its origin in an idea that a region capable of being stored under the same condition is stored in block in a storage region (surface) when multiple storage is performed in the optical storage medium. Since the foregoing construction is adopted, first, the first information group is stored under the first condition in the plurality of first illumination regions in the same state, and next, storage is performed under the second condition in the second illumination regions which overlap the first illumination regions. Therefore, in order to perform multiple storage having multiplicity of m, it is enough to adjust the illumination condition only m times. Further, time until writing the first information group is finished can be time for photochemical reaction in the individual first illumination regions. Therefore, the multiple storage method can be performed sequentially. The multiple storage method which performs recording and reproduction under the same condition in units of surface as the invention is called surface multiple storage method. This surface multiple storage method can be applied to both shift multiple storage method and angle multiple storage method.

Further, the optical information recording method of the invention is characterized in that the plurality of first illumination regions do not overlap each other.

Since such a construction is adopted, the respective first illumination regions are totally in the same state, and therefore the first information group can be uniformly stored by the illumination under the first condition.

Further, the optical information recording method of the invention is characterized in that a rate of overlapping between the second illumination region and the first illumination region is the same for the respective plurality of second illumination regions.

Since such a construction is adopted, the second information group to be stored in the second illumination regions can be accurately and uniformly stored under the second condition.

Further, the optical information recording method of the invention is characterized in that the second illumination region overlaps part of the first illumination region.

As above, when the surface multiple storage method of the invention is applied to the shift multiple storage method, adjustment of laser beam can be performed in block. Therefore, number of adjustment can be reduced, and control becomes easy. For example, where multiplicity in the periphery direction is m, number of rows in the radius direction is n, and multiplicity in the radius direction is x (x≦n), adjustment of intensity of laser beam of m×times has been required conventionally. However, in the invention, number of adjustment of intensity of laser beam becomes m×times. Further, time until writing the first information group is finished can be time for photochemical reaction in the individual first illumination regions. Therefore, the multiple storage method can be performed sequentially.

Further, the optical information recording method of the invention is characterized in that the second illumination region overlaps all area of the first illumination region.

As above, when the surface multiple storage method of the invention is applied to the angle multiple storage method, adjustment of laser beam can be performed in block. Therefore, number of adjustment can be reduced, and control becomes easy. For example, where multiplicity is m and number of illumination regions is n, adjustment of intensity of laser beam of m×n times has been required conventionally. However, in the invention, number of adjustment of intensity of laser beam becomes only m times. Further, time until writing the first information group is finished can be time for photochemical reaction in the individual first illumination regions. Therefore, the multiple storage method can be performed sequentially. Further, the respective information groups can be written while the optical information medium is rotated. Therefore, a transfer rate can be improved compared to in the conventional method.

Further, when the surface multiple storage method of the invention is applied to the angle multiple storage method, it is preferable that in the second condition, an entrance angle of the information light or the reference light for storage in relation to the optical storage medium is changed compared to in the first condition.

Since such a construction is adopted, in the angle multiple storage method, it is also enough to adjust the entrance angle of laser beam only m times.

Further, the optical information recording method of the invention is characterized in that the optical storage medium is divided into a plurality of zones, and storage of the first information group and storage of the second information group are performed in each zone.

Since such a construction is adopted, an angle velocity and a linear velocity of the optical storage medium can be maintained constant for each zone respectively. Therefore, the surface multiple storage method of the invention can provide further superior effect.

### BRIEF DESCRIPTION OF THE DRAWINGS

FIGS. 1 (A) through 1 (C) explain the surface multiple storage method of the present invention;

FIGS. 2(A) through 2(C) explain the surface multiple storage method of the present invention;

FIG. 3(A) is an outline cross sectional view of an optical storage medium taken along a track, and FIG. 3(B) is an outline plane view of the optical storage medium.

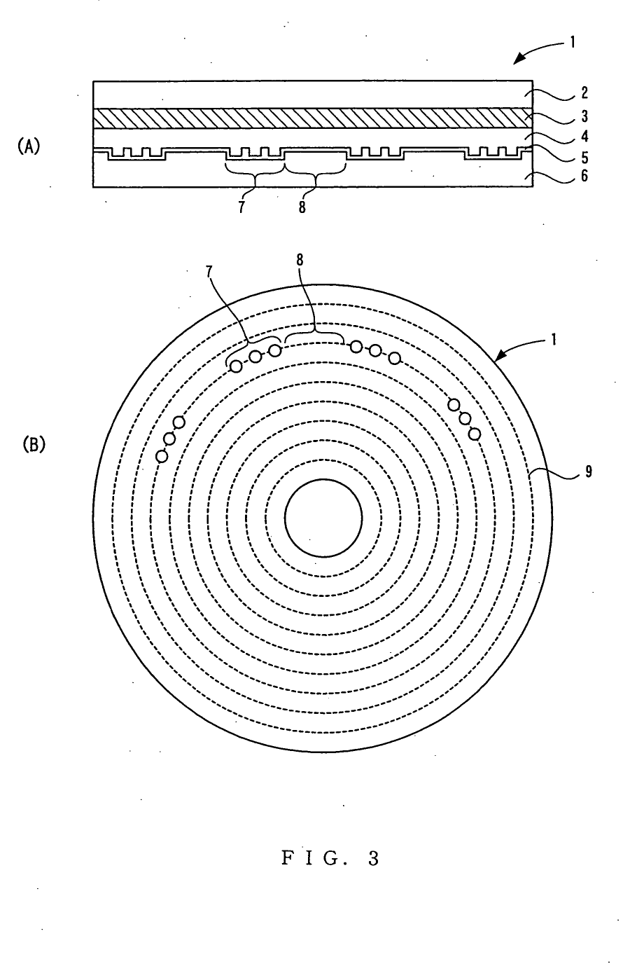

FIGS. 4(A) through 4(C) explain a conventional shift multiple storage method; and

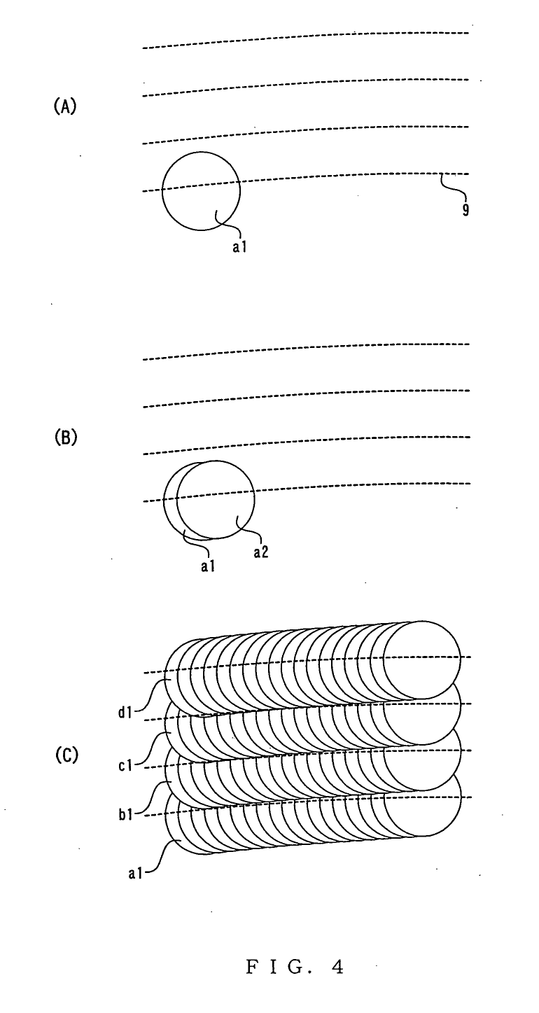

FIGS. 5(A) through 5(C) explain a conventional angle multiple storage method.

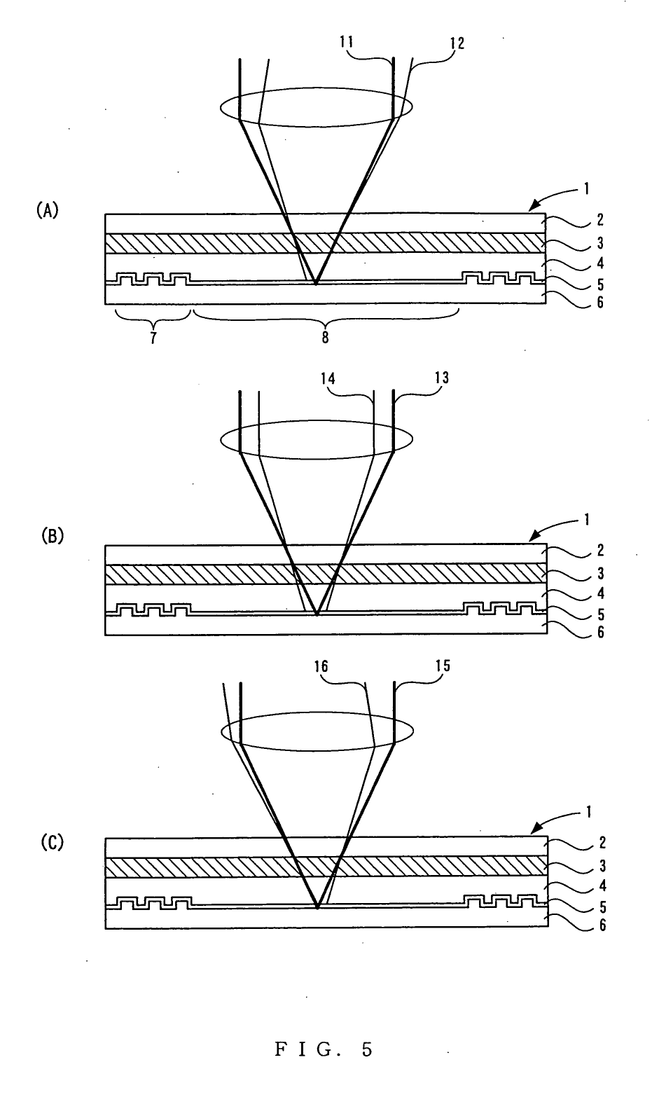

### DETAILED DESCRIPTION OF THE PREFERRED EMBODIMENT

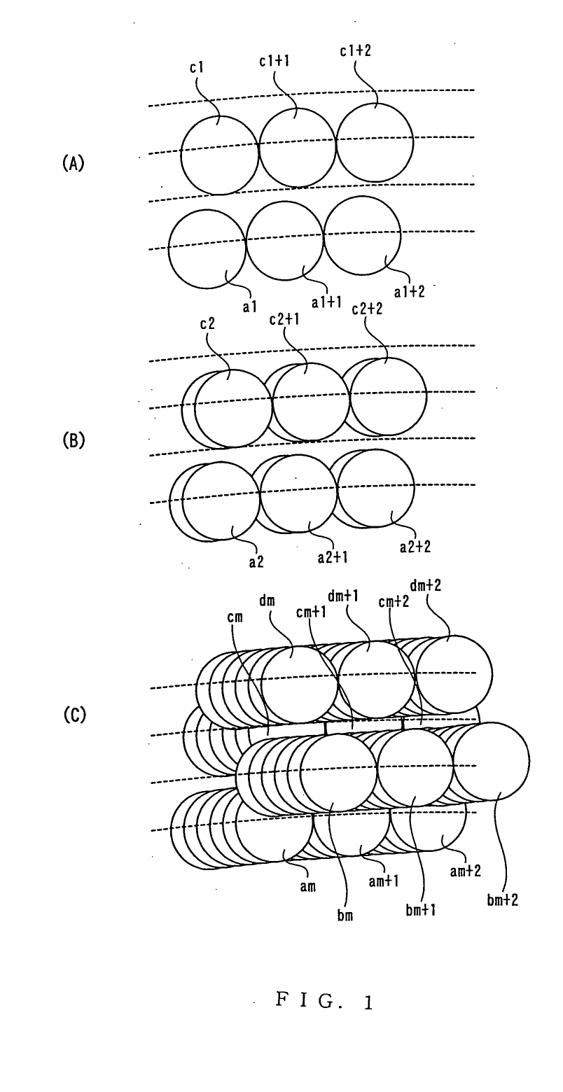

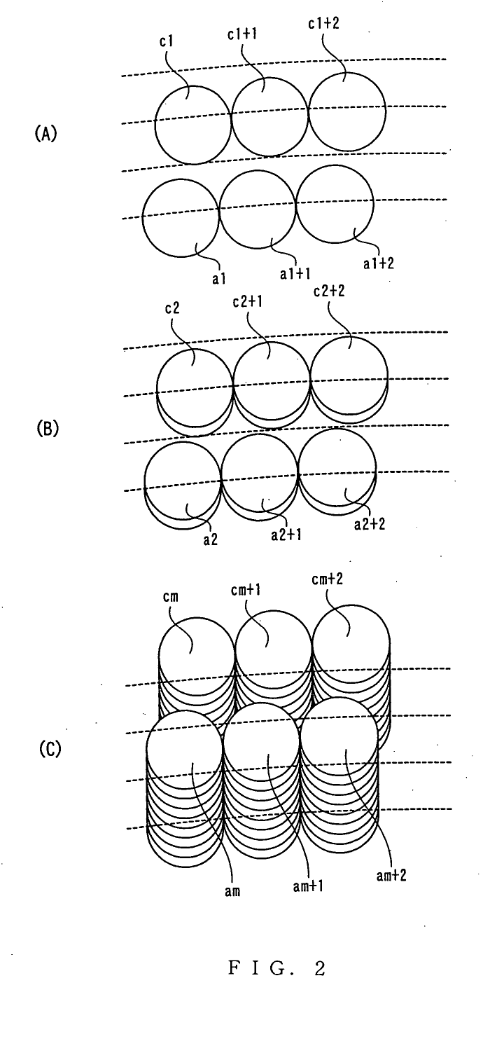

An embodiment of the invention will be hereinafter described with reference to the drawings. FIGS. 1(A) through 1(C) and FIGS. 2(A) through 2(C) are examples in which an optical information recording method of the invention is adopted to a shift multiple storage method. In FIGS. 1 (A) through 1 (C) and FIGS. 2(A) through 2(C), in order to simplify the figures, regarding illumination regions illuminated under the same condition, only three illumination regions in the periphery direction and only four illumination regions in the radius direction are shown.

The optical information recording method of the invention can be performed by devising order and arrangement of the multiple storage regions. Therefore, an optical storage medium having a construction similar to of the conventional optical storage medium can be used.

Before the optical information recording method of the invention is performed, illumination conditions of laser beam in storing respective information groups can be obtained by experiments in advance.

First, as shown in FIG. 1 (A) and FIG. 2(A), a first information group is stored by illuminating a plurality of places of an optical storage medium with information light and reference light for storage under a first condition and forming a plurality of first illumination regions a1 to a1+2 and c1 to c1+2. The respective first illumination regions al to al+2 and c1 to c1+2 are arranged so that each first illumination region does not overlap the adjacent first illumination region. If the first illumination region overlaps the adjacent first illumination region, arrangement is made so that their overlapping distance does not influence change of composition of their hologram storage layer.

As above, for the first illumination regions a1 to a1+2 and c1 to c1+2, the hologram storage layer of the optical storage medium is in the same condition. Therefore, respective illuminations of the information light to write therein and the reference light for storage can be performed under the same first condition. The first condition is an illumination condition suitable for the hologram storage layer in the initial state.

Next, as shown in FIG. 1 (B), a second information group is stored by illuminating the optical storage medium with the information light and the reference light for storage under a second condition shifting illumination positions from the first illumination regions in the periphery direction so that respective degrees of overlapping with the first illumination regions a1 to a1+2 and c1 to c1+2 can be the same, and forming a plurality of second illumination regions a2 to a2+2 and c2 to c2+2. The respective second illumination regions a2 to a2+2 and c2 to c2+2 overlap the first illumination regions with the same overlapping degree as each other, and therefore, their hologram storage layer of the optical storage medium is in the same state. Therefore, respective illuminations of the information light to write therein and the reference light for storage can be performed under the same second condition. Further, as shown in FIG. 2(B), when the second information group is stored, the second illumination regions a2 to a2+2 and c2 to c2+2 can be shifted in the radius direction of the optical storage medium instead of the periphery direction.

The second condition can be determined by a rate of overlapping between the second illumination region and the first illumination region. The larger an overlapping area is, the less an amount of reactant in the hologram storage layer becomes and the stronger required illumination intensity becomes.

Similarly, a third information group is stored by illuminating the optical storage medium with the information light and the reference light for storage under a third condition shifting illumination positions in the periphery direction or the radius direction so that respective degrees of overlapping between the first illumination regions and the second illumination regions can be the same as each other. When this process is repeated m times, multiple storage having multiplicity of m can be performed in a given region of the optical storage medium as shown in FIG. 2(C).

When multiple storage is performed by shifting the illumination positions in the periphery direction, as shown in FIG. 1(C), it is possible that after a1+x to am+x and c1+x to cm+x (x=0, 1, and 2) are stored by overlapping information m times in the periphery direction, illumination positions are shifted in the radius direction, and then further b1+x to bm+x and d1+x to dm+x (x=0, 1, and 2) are stored by overlapping information in the periphery direction. In this case, number of times to adjust laser beam doubles correspondingly to number of rows overlapping a clearance between the first illumination regions, which are adjacent in the radius direction (2 rows in FIG. 1 (C)), that is, multiplicity in the radius direction.

As above, storing one information group can be performed under a certain condition, and adjustment of laser beam can be performed in block. Therefore, number of times of adjustment can be decreased, and control becomes easy. Further, time until writing the information group is finished can be time for photochemical reaction in the individual illumination regions. Therefore, the shift multiple storage method can be performed sequentially.

Further, the optical information recording method of the invention can be also applied to an angle multiple storage method. First, as in the shift multiple storage method, a first information group is stored by illuminating a plurality of places of an optical storage medium with information light and reference light for storage under a first condition and forming a plurality of first illumination regions a1 to a1+2 and c1 to c1+2 as in FIG. 1(A) and FIG. 2(A). The respective first illumination regions alto a1+2 and c1 to c1+2 are arranged so that each first illumination region does not overlap the adjacent first illumination region. If the first illumination region overlaps the adjacent first illumination region, arrangement is made so that their overlapping distance does not influence change of composition of their hologram storage layer.

Next, a second information group is stored by illuminating the first illumination regions a1 to a1+2 and c1 to c1+2 with the information light and the reference light for storage under a second condition in which an entrance angle, intensity of laser beam and the like are changed. In this case, the second illumination region overlaps all area of the first illumination region.

Further, after storage of the second information group is finished, a third information group is stored by illuminating the first illumination regions a1 to a1+2 and c1 to c1+2 with the information light and the reference light for storage under a third condition in which an entrance angle, intensity of laser beam and the like are further changed. When this process is repeated m times, multiple storage having multiplicity of m can be performed in a given region of the optical storage medium.

As above, in the optical information recording method of the invention, the angle multiple storage having multiplicity of m can be performed by adjustment of m times. Further, the respective information groups can be written while the optical information medium is rotated. Therefore, a transfer rate can be improved compared to in the conventional method.

Further, it is also possible to divide the optical storage medium into several zones, and to store respective information groups in the respective zones. Conventionally, ZCAV (Zone Constant Angular Velocity) method, in which a storage medium is divided into several zones and each zone has each certain angular velocity, and ZCLV (Zone Constant Linear Velocity) method, in which each zone has each certain linear velocity have been known.

In the ZCAV method, the closer to an outer periphery of the optical storage medium the zone is, the larger number of sectors can be and the higher a transfer rate of reading and writing can be. A storage density can be maintained at the outer periphery of the optical storage medium, and a disc capacity can be increased. When the optical information recording method of the invention is applied to this ZCAV method, it is not necessary to change angle velocities until writing in a zone is finished. Therefore, control in storing information becomes further easy.

In the ZCLV method, change of a rotational velocity of the disc can be maintained within a certain range, and a recording density can be improved. When the optical information recording method of the invention is applied to this ZCLV method, information storage state can be further uniform, since not only a condition of laser beam in storing respective information groups, but also a linear velocity is the same in a zone.

As above, in the optical information recording method of the invention, by combining multiple storage for each zone with the method in which an angle velocity and a linear velocity are the same for each zone respectively, conditions can be standardized, and further superior effects can be obtained.

As described above, according to the invention, first, the first information group is stored under the first condition in the plurality of first illumination regions in the same state, and secondly the second information group is stored under the second condition in the second illumination regions overlapping the first illumination regions. Therefore, multiple storage having multiplicity of m is performed. Consequently, it is enough to adjust illumination conditions only m times. Further, time until writing the first information group is finished can be time for photochemical reaction in the individual first illumination regions. Therefore, the multiple storage method can be performed sequentially.

Further, when the plurality of first illumination regions do not overlap each other, the respective first illumination regions are totally in the same state as each other. Therefore, it is possible to store the first information group uniformly by illumination under the first condition.

Further, a rate of overlapping between the second illumination region and the first illumination region is the same for the plurality of second illumination regions as each other. Therefore, the second information group to be stored in the second illumination regions can be stored accurately and uniformly under the second condition.

Further, when the optical information recording method of the invention is applied to the shift multiple storage method, in which the second illumination region overlaps part of the first illumination region, adjustment of laser beam can be performed in block. Therefore, number of adjustment can be reduced, and control becomes easy. For example, where multiplicity in the periphery direction is m, number of rows in the radius direction is n, and multiplicity in the radius direction is x (x≦n), adjustment of intensity of laser beam of m×n times has been required conventionally. However, in the invention, number of adjustment of intensity of laser beam becomes m×x times. Further, time until writing the first information group is finished can be time for photochemical reaction in the individual first illumination regions. Therefore, the multiple storage method can be performed sequentially.

Further, when the optical information recording method of the invention is applied to the angle multiple storage method, in which the second illumination region overlaps all area of the first illumination region, adjustment of laser beam can be performed in block. Therefore, number of adjustment can be reduced, and control becomes easy. For example, where multiplicity is m and number of illumination regions is n, adjustment of intensity of laser beam of m×n times has been required conventionally. However, in the invention, number of adjustment of intensity of laser beam becomes only m times. Further, time until writing the first information group is finished can be time for photochemical reaction in the individual first illumination regions. Therefore, the multiple storage method can be performed sequentially. Further, the respective information groups can be written while the optical storage medium is rotated. Therefore, a transfer rate can be improved compared to in the conventional method.

Further, in the case that the optical information recording method is applied to the angle multiple storage method, when an entrance angle of the information light or the reference light for storage in relation to the optical storage medium is also changed in the second condition compared to in the first condition, adjustment of an entrance angle of laser beam becomes only m times in the angle multiple storage method.

Further, when the optical storage medium is divided into a plurality of zones, and the first information group and the second information group are stored in each zone, and an angle velocity and a linear velocity of the optical storage medium is maintained constant for each zone respectively, the surface multiple storage method of the invention can provide further superior effect.

1. An optical information recording method, in which an optical storage medium is illuminated with information light carrying information by spatial modulation and reference light for storage, and an interference pattern between the information light and the reference light for storage in an illumination region is stored as the information,
wherein a first information group is stored by illuminating a plurality of places of the optical storage medium with the information light and the reference light for storage under a first condition, and forming a plurality of first illumination regions,
and wherein a second information group is stored by illuminating a plurality of places of the optical storage medium with the information light and the reference light for storage under a second condition so that illumination regions overlap the first illumination regions, and forming a plurality of second illumination regions.

2. The optical information recording method according to claim 1, wherein the plurality of first illumination regions do not overlap each other.

3. The optical information recording method according to claim 1, wherein a rate of overlapping between the second illumination region and the first illumination region is the same for the respective plurality of second illumination regions.

4. The optical information recording method according to claim 1 , wherein the second illumination region overlaps part of the first illumination region.

5. The optical information recording method according to claim 1, wherein the second illumination region overlaps all area of the first illumination region.

6. The optical information recording method according to claim 5, wherein in the second condition, an entrance angle of the information light or the reference light for storage in relation to the optical storage medium is changed compared to in the first condition.

7. (cancelled).

8. The optical information recording method according to claim 2, wherein a rate of overlapping between the second illumination region and the first illumination region is the same for the respective plurality of second illumination regions.

9. The optical information recording method according to claim 2, wherein the second illumination region overlaps part of the first illumination region.

10. The optical information recording method according to claim 2, wherein the second illumination region overlaps all area of the first illumination region.

11. The optical information recording method according to claim 10, wherein in the second condition, an entrance angle of the information light or the reference light for storage in relation to the optical storage medium is changed compared to in the first condition.

12. The optical information recording method according to claim 3, wherein the second illumination region overlaps part of the first illumination region.

13. The optical information recording method according to claim 3, wherein the second illumination region overlaps all area of the first illumination region.

14. The optical information recording method according to claim 13, wherein in the second condition, an entrance angle of the information light or the reference light for storage in relation to the optical storage medium is changed compared to in the first condition.

15. The optical information recording method according to claim 8, wherein the second illumination region overlaps part of the first illumination region.

16. The optical information recording method according to claim 8, wherein the second illumination region overlaps all area of the first illumination region.

17. The optical information recording method according to claim 16, wherein in the second condition, an entrance angle of the information light or the reference light for storage in relation to the optical storage medium is changed compared to in the first condition.

18. The optical information recording method according to any one of claims 1 through 16, wherein the optical storage medium is divided into a plurality of zones, and storage of the first information group and storage of the second information group are performed in each zone.
